(19) United States
(12) Patent Application Publication
(10) Pub. No.: US 2023/0007385 A1
(43) Pub. Date: Jan. 5, 2023

(54) HEADPHONE

(71) Applicant: YAMAHA CORPORATION, Tokyo (JP)

(72) Inventor: Yuu TSUCHIHASHI, Hamamatsu-shi (JP)

(21) Appl. No.: 17/943,473

(22) Filed: Sep. 13, 2022

Related U.S. Application Data
(63) Continuation of application No. PCT/JP2021/005221, filed on Feb. 12, 2021.

(30) Foreign Application Priority Data
Mar. 25, 2020 (JP) 2020-053743

(51) Int. Cl. H04R 1/10; H04R 1/28; H04R 1/22

(52) U.S. Cl. CPC H04R 1/1075; H04R 1/1008; H04R 1/2807; H04R 1/227

(57) ABSTRACT

A headphone includes: a housing including a first aperture; a first driver unit disposed in the housing; a partition wall dividing an internal space of the housing into a first space and a second space, the first space communicating with an external space through the first aperture and containing the first driver unit; and a second driver unit attached to the partition wall.

### CROSS-REFERENCE TO RELATED APPLICATION

This application is a continuation application of International Application PCT/JP2021/005221 filed on Feb. 12, 2021, which claims priority from Japanese patent application JP2020-053743 filed on Mar. 25, 2020. The contents of these applications are incorporated herein by reference in their entirety.

### BACKGROUND

### 1. Field

This disclosure relates to a headphone.

### 2. Description of the Related Art

Recently, a reproduction capability of a headphone in a low range has become an important factor (WO2015/076006). To improve efficiency in the low range, a driver unit tends to be larger in size. Alternatively, reproduction in the low range may be improved by increasing a stroke of the driver unit.

An increase in size of the driver unit leads to generation of division vibration in a high range and poor acoustic characteristics in the high range. Or, the increase of the stroke of the driver unit leads to deterioration of sound quality in the low range, such as increased distortion. In addition, to improve a sense of separation between the low range and the high range in terms of auditory impression, a sound pressure level in a midrange (e.g., around 300 Hz to 1000 Hz) needs to be relatively lowered on frequency characteristics.

### SUMMARY

This disclosure aims to improve acoustic characteristics.

A headphone includes: a housing including a first aperture;

a first driver unit disposed in the housing; a partition wall dividing an internal space of the housing into a first space and a second space, the first space communicating with an external space through the first aperture and containing the first driver unit; and a second driver unit attached to the partition wall.

### BRIEF DESCRIPTION OF THE DRAWINGS

FIG. 1 is a partial schematic view of a headphone.

FIG. 2 is an overall view of the headphone.

FIG. 3 is a plan view of a housing.

FIG. 4 is a III-III cross-sectional perspective view of the housing in FIG. 3.

FIG. 5 is a circuit diagram of an acoustic adjustment circuit.

FIG. 6 is a schematic view of a structure in Comparative Example 1.

FIG. 7 is a schematic view of a structure in Comparative Example 2.

FIG. 8 is a diagram of results of simulated frequency characteristics in Comparative Examples 1 and 2.

FIG. 9 is a schematic view of a structure in Comparative Example 3.

FIG. 10 is a schematic view of a structure in Comparative Example 4.

FIG. 11 is a diagram of results of simulated frequency characteristics in the embodiment and Comparative Examples 3 and 4.

FIG. 12 is a cross-sectional perspective view of a housing according to a modification.

FIG. 13 is a diagram of results of simulated frequency characteristics in the modification and the embodiment.

### DETAILED DESCRIPTION

Hereinafter, some embodiments will be described with reference to the drawings. Here, the invention can be embodied according to various aspects within the scope of the invention without departing from the gist of the invention and is not construed as being limited to the content described in the embodiments exemplified below.

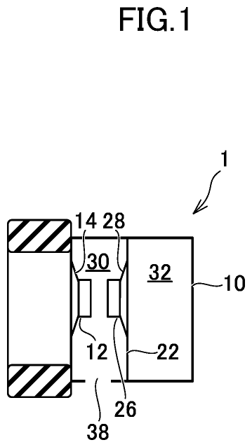

FIG. 1 is a partial schematic view of a headphone. The headphone 1 includes a housing 10 with a first aperture 38, a first driver unit 12 installed in the housing 10, a partition wall 22 to divide an internal space of the housing 10 into a first space 30 and a second space 32, where first space 30 has the first driver unit 12 installed therein and is connected to an external space through the first aperture 38, and a second driver unit 26 attached to the partition wall 22. The first driver unit 12 and the second driver unit 26 have a first diaphragm 14 and a second diaphragm 28, respectively, that are asymmetric in shape, in a vibration direction, such as a dome shape convex on a front side or an almost circular trapezoidal shape (cone shape).

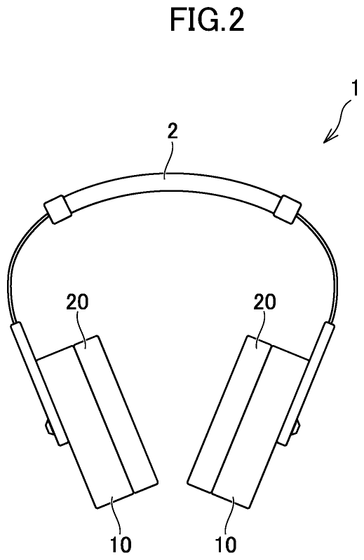

FIG. 2 is an overall view of the headphone. The headphone 1 is wired to or wirelessly connected to an unillustrated audio device (e.g., music player, sound mixer, smartphone). The headphone 1 has a headband 2 and a pair of housings 10. The headphone 1 may have a noise cancelling function. An earphone shall be a kind of the headphone 1.

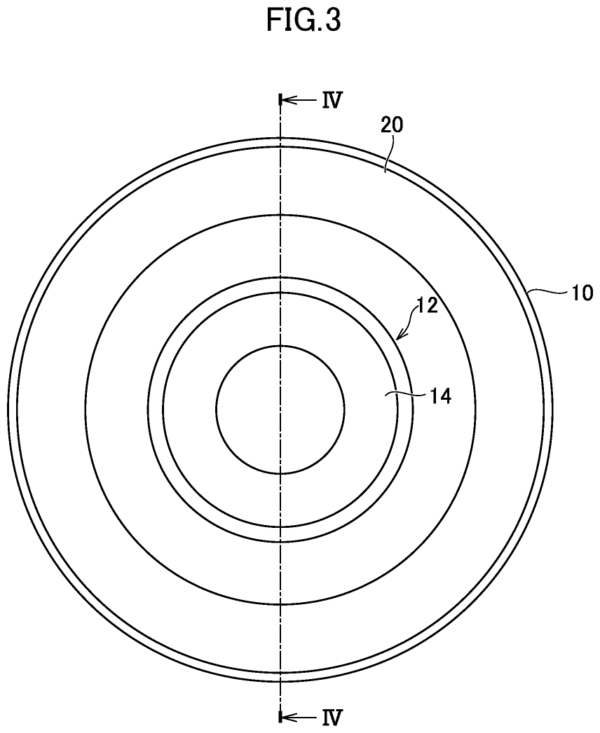

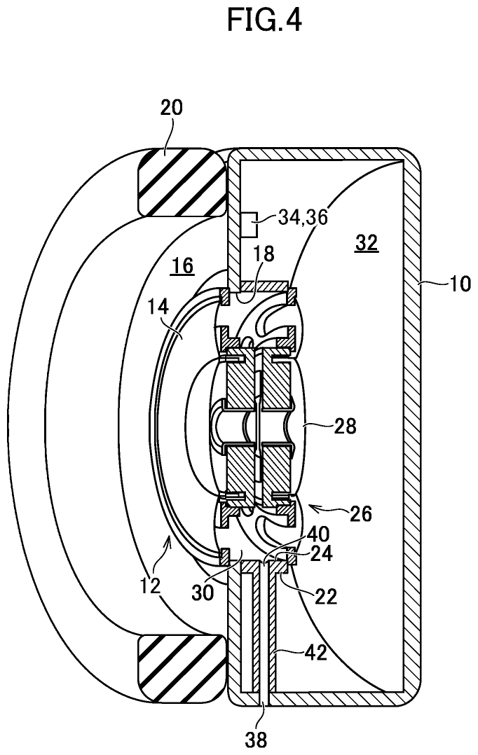

FIG. 3 is a plan view of the housing 10. FIG. 4 is a III-III cross-sectional perspective view of the housing 10 in FIG. 3. The first driver unit 12 is attached to the housing 10. The first driver unit 12 is configured to reproduce sound from electrical signals of original sound such as music. If it is a dynamic type, the sound is reproduced by passing an electric current through a coil based on the electric signals and vibrating the first diaphragm 14 by magnetic force. The first diaphragm 14 has a dome shape that is convex on a front side. In other words, a portion that is convex on a front surface is concave on a rear surface. Due to this asymmetry of the shape in the vibration direction, the sound reproduced by the first driver unit 12 have distortion (secondary distortion).

The housing 10 has a first opening 18 in an output surface 16 to be opposed to a user's ear. The first diaphragm 14 of the first driver unit 12 is attached to the output surface 16 to block the first opening 18. An ear cup 20 is attached to the output surface 16, surrounding the first opening 18 and the first driver unit 12.

A partition wall 22 is attached to the housing 10. The partition wall 22 has a second opening 24. A second diaphragm 28 of the second driver unit 26 is attached to the partition wall 22 to block the second opening 24. The second driver unit 26 has the same structure (e.g., dynamic type) as the first driver unit 12. The second diaphragm 28 has a dome shape that is convex on a front side.

The partition wall 22 divides an internal space of the housing 10 into the first space 30, where the first driver unit 12 is installed, and the second space 32. The first driver unit 12 faces the first space 30 and the external space. The first diaphragm 14 has a rear surface facing the first space 30. The second driver unit 26 faces both the first space 30 and the second space 32. The second diaphragm 28 has a rear surface facing the first space 30. The first driver unit 12 and the second driver unit 26 are opposed to each other.

The first space 30 is a closed space since the first opening 18 and the second opening 24 are blocked by the first diaphragm 14 and the second diaphragm 28, respectively. The first space 30 is behind the first diaphragm 14, whereby sound quality of the first driver unit 12 is determined by an impact of air pressure in the first space 30 on the vibration of the first diaphragm 20. On the other hand, the first space 30 is behind the second diaphragm 28, whereby volume (capacity) of the first space increases or decreases due to vibration of the second diaphragm 28, and air pressure in the first space 30 changes. An electrical board 34 is located in the housing 10. The acoustic adjustment circuit 36 for driving the second driver unit 26 is included in the electrical board 34.

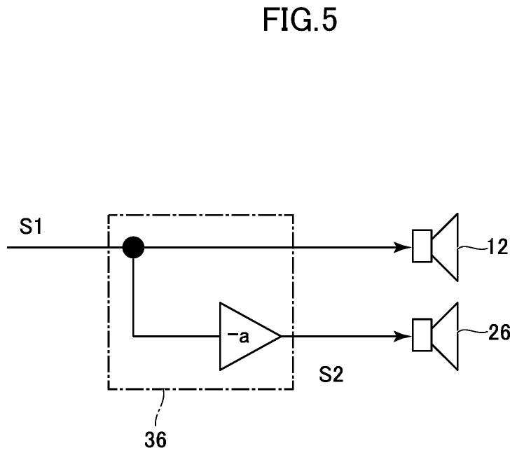

FIG. 5 is a circuit diagram of the acoustic adjustment circuit 36. The first driver unit 12 is configured to have a first signal S1 input thereto. The acoustic adjustment circuit 36 is configured to generate a second signal S2 based on the first signal S1. The second driver unit 26 is configured to have the second signal S2 input thereto. The second driver unit 26 enables change of the air pressure in the first space 30.

For example, the acoustic adjustment circuit 36 is configured to generate the second signal S2 in an opposite phase to the first signal S1 in a first band arbitrarily configurable. The reason for the opposite phase is that the first diaphragm 14 and the second diaphragm 28 have respective front surfaces opposite to each other (see FIG. 4). The first band may be a partial frequency band or an entire frequency band. By setting the second signal S2 to the opposite phase to the first signal S1 in the first band, the first diaphragm 14 and the second diaphragm 28 vibrate in the same direction with the same timing, whereby volume of the closed space (first space 30) changes little. This mitigates an effect of an air spring and increases sound pressure sensitivity in a low frequency range. In addition, the distortion (secondary distortion) caused by the asymmetry of the diaphragm shapes in the vibration direction is reduced.

As shown in FIG. 4, the housing 10 has the first aperture 38. A surface with the first aperture 38 is different from a surface (output surface 16) with the first driver unit 12. The first space 30 is connected to the external space through the first aperture 38, but the second space 32 is not connected to the external space. In detail, the partition wall 22 has an opening 40, and both ends of a pipe 42 are connected to the opening 40 and the first aperture 38, respectively. In the first space 30, air vibration occurs near the opening 40 to excite Helmholtz resonance. This causes the first diaphragm 14 to vibrate very little in the resonant frequency range, and acoustic radiation on the front surface of the first diaphragm 14 is drastically reduced, resulting in a dip in frequency characteristics.

For example, by creating the dip in the frequency characteristics in a band from 300 Hz to 1000 Hz (midrange), it is possible to reduce the sound pressure in the midrange and relatively increase the sound pressure in the low and high ranges to form a sound with a good sense of separation. In a band lower than the resonance frequency, the second driver unit 26 (second diaphragm 28) can vibrate the air in the first space 30 in the same phase as the first diaphragm 14. Therefore, the effect of the air spring behind the first diaphragm 14 can be eliminated as much as possible, and as a result, the sound pressure level in the low frequency range can be increased.

This embodiment can reproduce a high-quality sound with a good sense of separation between low and high frequencies, while ensuring low sound pressure compared to a conventional structure with the same chassis size.

### EXAMPLES

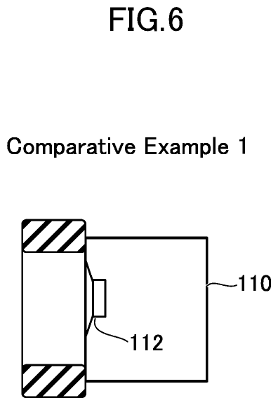

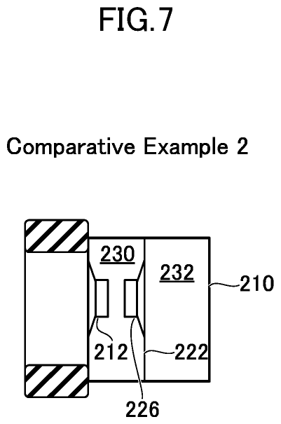

FIG. 6 is a schematic view of a structure in Comparative Example 1. In Comparative Example 1, the housing 110 has a sealed structure and includes the first driver unit 112, but it differs from the embodiment in that there are no partition wall and no second driver unit. FIG. 7 is a schematic view of a structure in Comparative Example 2. In Comparative Example 2, the housing 210 has a sealed structure and includes the first driver unit 212 and the second driver unit 226 in the first space 230, but it differs from the embodiment in that there is no first aperture.

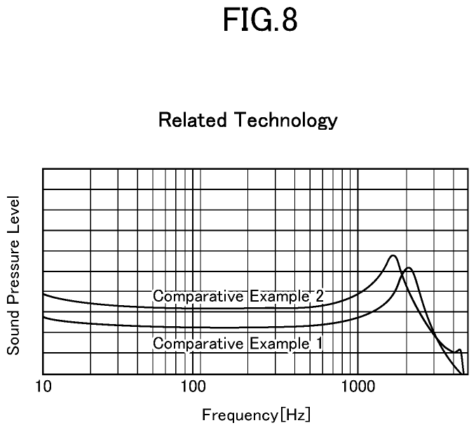

FIG. 8 is a diagram of results of simulated frequency characteristics in Comparative Examples 1 and 2. Comparative Example 2 is higher in sound pressure level than Comparative Example 1. In other words, as in the present embodiment, the internal space of the housing 210 is divided into the first space 230 and the second space 232 by the partition wall 222, thereby showing superiority of the structure that reduces the effect of the air spring in the first space 230.

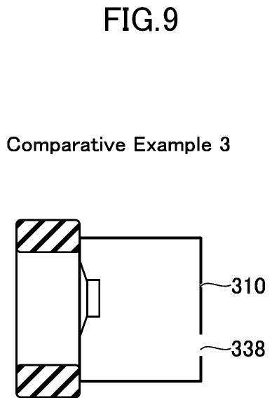

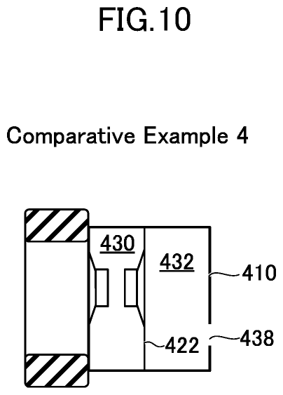

FIG. 9 is a schematic view of a structure in Comparative Example 3. Comparative Example 3 differs from Comparative Example 1 in that an aperture 338 is formed in the housing 310. FIG. 10 is a schematic view of a structure in Comparative Example 4. Comparative Example 4 differs from Comparative Example 2 in that an aperture 438 connected to the second space 432 is formed in the housing 410.

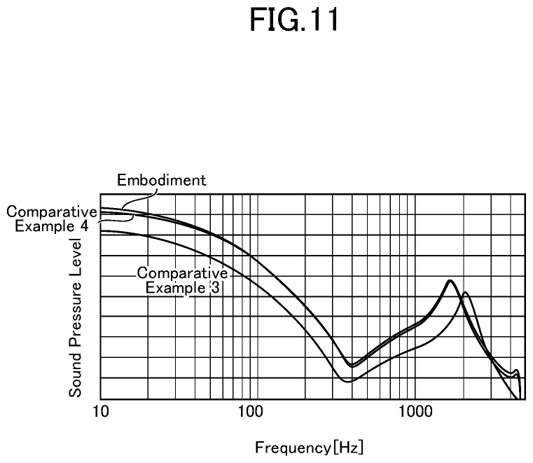

FIG. 11 is a diagram of results of simulated frequency characteristics in the embodiment and Comparative Examples 3 and 4. Comparative Example 4 is higher in the sound pressure level than Comparative Example 3. As in the present embodiment, the internal space of the housing 410 is divided into the first space 430 and the second space 432 by the partition wall 422, thereby showing superiority of the structure that reduces the effect of the air spring in the first space 430. Furthermore, as shown in FIG. 4, the embodiment, where the first space 30 is connected to the external space through the first aperture 38, is higher in the sound pressure level (especially in the low frequency) than Comparative Examples 3 and 4.

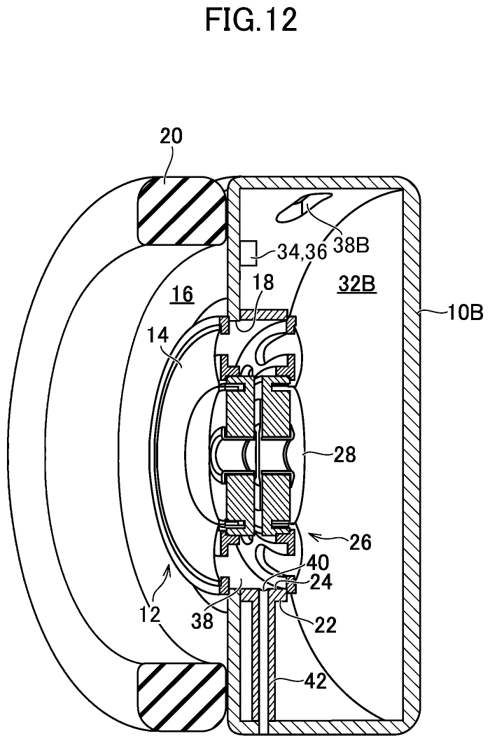

FIG. 12 is a cross-sectional perspective view of a housing according to a modification. The housing 10B has a second aperture 38B. Through the second aperture 38B, the second space 32B is connected to the external space. The other structure is the same as the structure of the embodiment.

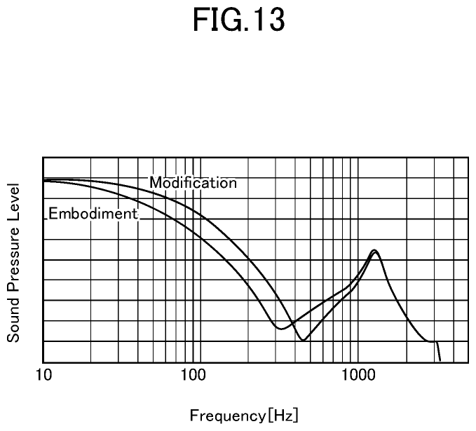

FIG. 13 is a diagram of results of simulated frequency characteristics in the modification and the embodiment. It is shown that the modification is higher in the sound pressure level than the embodiment.

The invention is not limited to the embodiments described above and different variations are possible. The structures explained in the embodiments may be replaced with substantially the same structures and other structures that can achieve the same effect or the same objective.

What is claimed is:

1. A headphone comprising:
a housing including a first aperture;
a first driver unit disposed in the housing;
a partition wall dividing an internal space of the housing into a first space and a second space, the first space communicating with an external space through the first aperture and containing the first driver unit; and
a second driver unit attached to the partition wall.

2. The headphone according to claim 1, further comprising an acoustic adjustment circuit configured to receive a first signal to be input to the first driver unit and generate a second signal to be input to the second driver unit based on the first signal.

3. The headphone according to claim 2, wherein the generated second signal is in an opposite phase to the first signal.

4. The headphone according to claim 1, wherein:
the first driver unit is attached to a surface of the housing, and
the first aperture is formed in a surface different from the surface where the first driver unit is attached.

5. The headphone according to claim 1, wherein:
the first driver unit includes a first diaphragm,
the second driver unit includes a second diaphragm,
the first diaphragm includes a rear surface facing the first space, and
the second diaphragm includes a rear surface facing the first space.

6. The headphone according to claim 5, wherein each of the first diaphragm and the second diaphragm is dome shaped, with a convex curve on a front side.

7. The headphone according to claim 1, wherein the first driver unit and the second driver unit are disposed opposing each other.

8. The headphone according to claim 1, wherein the housing includes a second aperture communicating the second space to the external space.

9. The headphone according to claim 1, wherein the first driver unit and the second driver unit have the same structure.

10. The headphone according to claim 1, wherein the first aperture is shaped to excite Helmholtz resonance and produce a dip in frequency characteristics of a band from 300 Hz to 1000 Hz.

11. A headphone comprising:
a first housing including a first aperture;
a first driver unit disposed in the first housing;
a first partition wall dividing a first internal space of the first housing into a first space and a second space, the first space communicating with an external space through the first aperture and containing the first driver unit;
a second driver unit attached to the first partition wall;
a second housing including a second aperture;
a third driver unit disposed in the second housing;
a second partition wall dividing a second internal space of the second housing into a third space and a fourth space, the third space communicating with the external space through the second aperture and containing the third driver unit; and
a fourth driver unit attached to the second partition wall.

12. The headphone according to claim 11, further including a headband connecting the first and second housings.

13. The headphone according to claim 12, further including:
a first ear cup attached to the first housing; and
a second ear cup attached to the second housing.
